(19) United States
(12) Patent Application Publication
(10) Pub. No.: US 2022/0228295 A1
(43) Pub. Date: Jul. 21, 2022

(54) Synthesis of Refractory Transition Metal-Carbide Fibers

(71) Applicant: National Technology & Engineering Solutions of Sandia, LLC, Albuquerque, NM (US)

(72) Inventors: LaRico Juan Treadwell, Albuquerque, NM (US); James Nicholas, Albuquerque, NM (US); Nelson S. Bell, Albuquerque, NM (US)

(21) Appl. No.: 17/486,600

(22) Filed: Sep. 27, 2021

Related U.S. Application Data
(60) Provisional application No. 63/085,490, filed on Sep. 30, 2020.

(51) Int. Cl. D01D 5/00; D06M 11/74; D01F 11/00

(52) U.S. Cl. CPC D01D 5/0061; D01F 11/00; D01D 5/0046; D06M 11/74

(57) ABSTRACT

Refractory transition metal-carbide (RTM-C) fibers were synthesized via the Forcespinning™ method. This method allows for simple and rapid synthesis of these RTM-C fibers with the ability to make grams of fibers quickly.

### CROSS-REFERENCE TO RELATED APPLICATION

This application claims the benefit of U.S. Provisional Application No. 63/085,490, filed Sep. 30, 2020, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to method to synthesize fibers and, in particular, to a method to synthesize refractory transition metal-carbide fibers.

### BACKGROUND OF THE INVENTION

While refractory transition metal-carbides (RTM-Cs) have been studied as far back as the 1800s, interest in these materials increased in the late 1950s as the space race intensified. Research on RTM-Cs gained even more interest during the late 1980s for aerospace applications, such as hypersonic flight. As hypersonic technology pushes speeds beyond Mach 5, surface temperatures can reach upwards of 2000° C. in the presence of highly reactive gas species. See W. G. Fahrenholtz and G. E. Hilmas, Scr. Mater. 129, 94 (2017). Therefore, materials that can survive/mitigate these extreme environments are critical for the future application of hypersonic technologies. Currently, carbon/carbon (C/C) composites are the material of choice due to their mechanical, thermal and shock properties. Unfortunately, carbon is susceptible to oxidation at high temperature in various environments and has poor stability in strong erosion environments. See A. Vinci et al., J. Eur. Ceram. Soc. 39(4), 780 (2019). Silicon carbide (SiC) fibers have also been investigated as a replacement for carbon fibers, however, SiC fibers can only retain their mechanical properties up to 1900° C. SiC generates gaseous reaction products through native oxidation from a combination of temperature >1100° C., high pressure, and external gas flow. See W. Fahrenholtz et al., J. Am. Ceram. Soc. 90(5), 1347 (2007). Due to the thermal limitation of carbon and silicon carbide fibers inhibiting ultra-high temperature performance, RTM-C materials for use in high temperature environments have been identified as viable replacements. See W. G. Fahrenholtz and G. E. Hilmas, Scr. Mater. 129, 94 (2017). RTM-C materials possess strong covalent bonding and degrees of metallic bonding that lead to high melting points (>3700° C.), high hardness, good high-temperature strength, high resistance to oxidation, excellent electrical conductivity, and exceptional resistance to harsh chemical and thermal environments. See K. A. Khalil et al., Materials (Basel) 9(5), 1 (2016); A. Vinci et al., J. Eur. Ceram. Soc. 39(4), 780 (2019); R. D. Vispute et al., Appl. Phys. Left. 90(24), 3 (2007); and J. Ma et al., Mater. Lett. 61(17), 3658 (2007). This combination of properties allows RTM-Cs to survive in more extreme environments than those of existing structural materials. Therefore, utilizing these RTM-C materials as fiber reinforcements in composites would significantly enhance the thermal resistance as well as the damage tolerance of ultra-high temperature composites. See A. Vinci et al., J. Eur. Ceram. Soc. 39(4), 780 (2019); W. Fahrenholtz et al., J. Am. Ceram. Soc. 90(5), 1347 (2007); Q. J. Hong and A. Van De Walle, Phys. Rev. B 92(2), 1 (2015); K. A. Khalil et al., Materials (Basel). 9(5), 1 (2016); A. Vinci et al., J. Eur. Ceram. Soc. 39(4), 780 (2019); R. D. Vispute et al., Appl. Phys. Lett. 90(24), 3 (2007); and J. Ma et al., Mater. Lett. 61(17), 3658 (2007).

To use these RTM-C materials as fiber reinforcements in composites, a readily scalable route to produce high quality materials in fiber form is needed. Methods to produce hafnium and tantalum carbide (HfC and TaC) materials have been reported in the literature that have led to the successful production of these materials in fiber and powder form. See M. Jalaly et al., Int. J. Refract. Met. Hard Mater. 79, 177 (2019). However, most of these methods utilize harsh reagents and halide precursors of the refractory transition metal, which are known to lead to impurities upon degradation (e.g., Cl-contamination). Furthermore, these methods are not all conducive to produce quality fibers through traditional techniques. Currently, the most common ways to fabricate fibers include melt-spinning, self-assembly, phase separation, and electrospinning methods. See J. Cheng et al., Ceram. Int. 44(6), 7305 (2018). Due to the simplicity and low-cost operation of electrospinning, it is the most commonly used method to fabricate nanofibers. Unfortunately, this technique has material/solvent limitations due to electrostatic fields and intrinsically low throughput via traditional lab scale electrospinning fabrication, which has been shown only to produce around 0.1 g/h of fibers. See Z. M. Zhang et al., J. Eng. Fiber. Fabr. 14, (2019); and V. A. Agubra et al., Solid State Ionics 286, 72 (2016). On the other hand, Obregon et al. produced polycaprolactone (PCL) fibers at a rate of 0.32 g in two minutes (scaled up to 9.6 g/hr) via the Forcespinning™ technique, which corresponds to a 3000% increase in output. See N. Obregon et al., Fibers 4(2), 20 (2016). Forcespinning™ is a process that is similar to electrospinning, except that the Forcespinning™ process uses centrifugal forces instead of electrostatic forces to generate fibers from a solution ejected from a spinning metal head. See V. A. Agubra et al., Solid State Ionics 286, 72 (2016). By using centrifugal forces, the viable material options for Forcespinning™ are not limited by their dielectric properties allowing a wide spectrum of material combinations. See K. Sarkar et al., Mater. Today 13(11), 12 (2010); and Z. M. Zhang et al., J. Eng. Fiber. Fabr. 14, (2019).

### SUMMARY OF THE INVENTION

The present invention is directed to a method for producing refractory transition metal-carbide (RTM-Cs) fibers using Forcespinning™ techniques by non-halide-based metal precursors. The method comprises providing a solution of polymer in a first solvent, providing a solution of a refractory transition metal alkoxide in a second solvent, combining the polyacrylonitrile solution with the refractory transition metal alkoxide solution to form a fiber solution, forcespinning the fiber solution to form fibers, and carbonizing the fibers at an elevated temperature to form refractory transition metal carbide fibers. A method can produce RTM-C fibers of a variety of refractory transition metals, including Ta, Hf, Zr, or Nb.

As examples of the invention, RTM-C fibers were synthesized via Forcespinning™ utilizing a mixture of polyacrylonitrile (PAN) and refractory transition metal alkoxides (i.e., tantalum(V) ethoxide and hafnium(IV) tert-butoxide) in a dimethyl formamide (DMF) solution based on optimal conditions. In all instances, after calcination, powder X-ray diffraction (PXRD) and energy dispersive spectroscopy (EDS) indicated TaC and HfC fibers were produced. TGA/DSC confirmed the thermal stability of the resulting TaC and HfC fibers.

### BRIEF DESCRIPTION OF THE DRAWINGS

The detailed description will refer to the following drawings, wherein like elements are referred to by like numbers.

FIG. 1(a) is a graph of viscosity versus shear rate of w/w PAN/DMF solution as a function of PAN content. FIG. 1(b) is a graph of specific viscosity vs vol % PAN solution. FIG. 1(c) is a graph of viscosity versus shear rate for a 15 wt % PAN solution compared to a 13 wt % PAN-Ta-OR precursor solution, showing similar high shear rate flow properties.

FIG. 2 is an image of fiber formed from 15% w/w PAN/DMF solution when spun at 3500 RPM and collecting rods at 17.78 cm away from the spinneret.

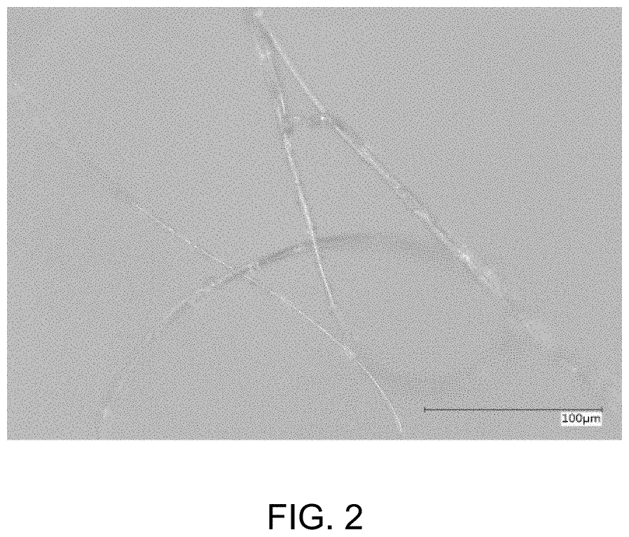

FIG. 3 is a powder x-ray diffraction (PXRD) spectrum of as synthesized TaC indexed with TaC.

FIG. 4 is a PXRD spectrum of as synthesized HfC indexed with HfC.

FIG. 5 shows scanning electron microscope (SEM) images of as spun TaC fibers after carbonization.

FIG. 6 is an energy dispersive spectroscopy (EDS) analysis of as spun TaC fibers after carbonization.

FIG. 7 shows SEM images of as spun HfC fibers after carbonization.

FIG. 8 is an EDS analysis of as spun HfC fibers after carbonization.

FIG. 9 is a thermogravimetric analysis (TGA) plot of TaC in air and in inert environment (N₂).

FIG. 10 is a TGA plot of HfC in air.

### DETAILED DESCRIPTION OF THE INVENTION

The present invention is directed to a novel method for producing stable RTM-C fibers using the Forcespinning™ technique and non-halide-based metal precursors. First, an ideal solution viscosity was systematically determined via rheological studies of neat PAN/DMF solutions. Next, Forcespinning™ parameters were systemically studied to determine the optimal angular velocity and spinneret-to-collecting rod distance required for ideal fiber formation. Lastly, metal precursor solution preparation, fiber processing parameters, and characterization data are described for exemplary TaC and HfC fibers. The invention enables the high-throughput production of RTM-C fibers for reinforcements in composites using the Forcespinning™ technique.

As an example of the invention, polyacrylonitrile (PAN, MW 150,000) in DMF solutions were prepared at various weight percentages ranging from 10-20% w/w. To prepare solutions, desired amounts of PAN and anhydrous DMF were added to a chemical jar with a magnetic stir bar. The solution was then sealed and allowed to stir until PAN was completely dissolved. A 3 mL aliquot of the PAN solution was drawn for the spinning process and 1 mL aliquot was drawn for rheological studies to compare the various PAN solution weight percentages.

The TaC fiber precursor solution comprised a PAN solution and tantalum(V) ethoxide solution combined. The PAN solution (13% w/w) recipe consisted of 3.897 g of PAN and 30 g of DMF. The reactants were added to a chemical jar with a magnetic stir bar; the solution was sealed and allowed to stir until PAN was completely dissolved. For the tantalum(V) ethoxide solution, 4.5 g of tantalum(V) ethoxide and 9.0 g of acetic acid were added to a chemical jar with a magnetic stir bar; the solution was sealed and allowed to stir until dissolved. The tantalum(V) ethoxide/acetic acid solution was then mixed with the PAN/DMF solution and stirred overnight ensuring full dissolution of the reagents, creating the “fiber solution”. Lastly, a 3 mL aliquot of the fiber solution was drawn for the spinning process and 1 mL aliquot was drawn for rheological studies to compare fiber solution to the optimal neat PAN solution. The same process was used with hafnium(IV) tert-butoxide precursor to generate HfC-fibers.

The RTM-C fibers were generated using the FibeRio L-1000M Cyclone Forcespinning™ System (FibeRio Technology Corp., http://www.fiberiotech.com/). See, e.g., U.S. Pat. No. 8,647,540 to Peno et al., issued Feb. 11, 2014. The Forcespinning™ technique uses centrifugal force to extrude a solution out of the spinning metal heads of a spinneret, forming fibers that are collected on vertical metal rods at chosen radial separation distances from a spinneret. A multistep program was created that consisted of spinning at 1000 rpm for the five seconds then ramping up to 3500 rpm for 1200 seconds. The metal rods were placed 17.78 cm away from the spinneret. The resulting fibers were then collected from the rods and placed in a box furnace, then heated to a temperature of 220° C. at a ramp rate of 5° C. per minute and held at that temperature for two hours. After cooling to room temperature, the fibers were then placed in a tube furnace at 1600° C. with a 5° C. ramp rate under the flow of argon and dwelled for two hours to carbonize the spun fiber material.

The production of fiber materials is non-trivial and relies on numerous synthetic and instrumental variables. Of the many parameters, the viscosity of the fiber solution is the most readily and easily tailorable to produce fiber materials. Therefore, rheological studies were done on PAN/DMF solutions to determine the optimal solution viscosity needed to produce fibers via Forcespinning™. PXRD, SEM/EDS, TGA, FTIR were used to qualitatively and quantitatively characterize the as-synthesized fibers. This suite of characterization techniques allows for observation of the formation of high purity fibers. The neat solution served as a surrogate to identify the optimal conditions for RTM-C solutions.

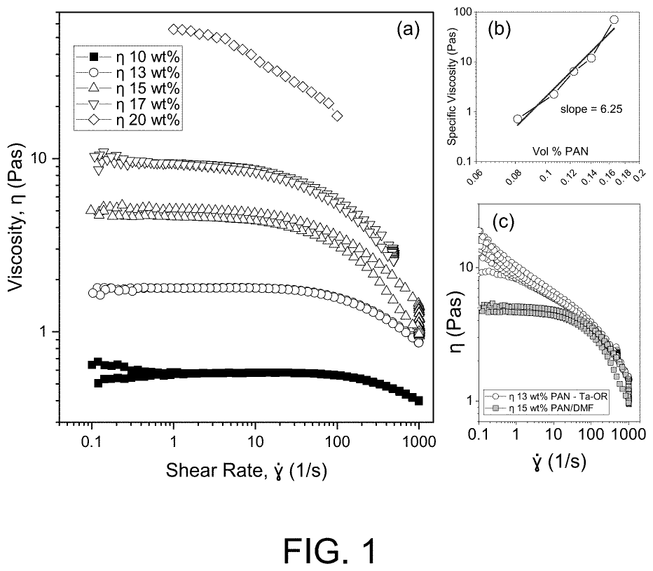

A rheological study of the viscosity of neat PAN/DMF solutions of various weight percentages from 10 to 20 wt % PAN as a function of shear rate was done to investigate the variation in the jet generation and extension behavior of the polymer solutions. The viscosity profile results are shown in FIG. 1(a). At 10 wt % (lowest loading), the PAN/DMF solution displays nearly Newtonian behavior, with a viscosity of 570 mPa*s up to a shear rate of about 200 1/s. As PAN content is increased, the polymer solutions show increasing viscosity levels. The transition to shear thinning behavior occurs at progressively lower shear rates, as the system exhibits further chain entanglement. All these solutions were expected to have chain entanglement characteristics based on prior literature of PAN/DMF solutions. See J. Diani et al., Poly. Sci. Eng. 46(4), 486 (2006). The stable formation of a fiber requires a polymer concentration sufficient to obtain chain entanglement. Zhang et al. presented rheological characterization of PAN/DMF solutions that determined a minimum concentration (Cₘᵢₙ) for the entry into the chain entanglement regime at approximately 5 wt %. For polymer solutions above Cₘᵢₙ, the specific viscosity follows the power law ηₛₚ˜ϕ^{4.78}. See Z. M. Zhang et al., J. Eng. Fiber. Fabr. 14, (2019). FIG. 1(b) plots the specific viscosity vs. volume % PAN that can be used to estimate the power law behavior for these solutions.

The production of fibers depends on the surface tension and viscosity of the polymer solution, chain entanglement, relaxation dynamics of the polymer solution, evaporation rate of the solvent, and extension forces on the fiber in transit from the orifice tip of the spinneret to the collector system. See C. Wang et al., Macromolecules 40(22), 7973 (2007). Operationally, three instrument parameters can be varied to control fiber formation: angular velocity (Ω), collector distance, and the polymer concentration. Forcespinning™ has a five-step process of fiber formation. The steps include (1) jet exit, (2) orbital trajectory, (3) aerodynamic fiber vibration, (4) orbital expansion, and (5) fiber collection. There is a critical angular velocity to produce a jet, but there is a second critical angular velocity in which the jet diameter is reduced well below the tip orifice diameter. See J. Cheng et al., Ceram. Int. 44(6), 7305 (2018). The fiber size should be relatively insensitive to the orifice diameter, which is important for the capillary back pressure needed to induced flow to the tip. There is a minimum rotational speed related to the fiber extension phase as well to prevent the fibers from being pulled back to the spinneret shaft, and a maximum speed related to the break-up of the polymer solution jet.

Fiber production by Forcespinning™ was first tested on pure PAN/DMF solutions to correlate solution viscosity to fiber formation, since viscoelastic instabilities can lead to formation of beads when viscosity is too low. The 10-13 wt % solution yielded poor nanofibers with droplets and beads due to low viscosity. The 17-20 wt % solution produced short nanofibers of low yield, indicating that the viscosity of the solution was too high for the given centrifugal force. However, the 15 wt % solution yielded uniform fibers with no droplets.

The 15 wt % PAN solution was investigated at different angular velocities and collector distances to determine the optimal conditions for fiber production. Fiber formation is drastically affected by varying spin speeds and collecting distances. Low rpm (≤2000 rpm) leads to droplet formation due to not achieving the critical angular velocities needed to reduce the fiber diameter below the orifice diameter. Too high of a rotational velocity (≥5000 rpm) leads to fibers that lack enough strength to form continuous fibers. The collecting distance can also be optimized in order to determine the distance from the spinneret at which the fibers are fully formed. Therefore, distances ranging from around 15 cm-18 cm for the collector were investigated. Systematic investigation of these variables based on the fiber formation and yield led to an optimal speed of 3500 rpm and an optimal collecting distance of 17.78 cm.

A starting point for the RTM-C precursor solution was to replicate similar viscosity properties as the 15 wt % PAN/DMF solution, given that the neat solution served as a surrogate. However, the addition of the tantalum(V) ethoxide/acetic acid solution to the 15 wt % PAN/DMF solution can increase the viscosity, which may lead to a change of solution performance. To account for the additional attraction between Ta-ethoxide and PAN, the PAN/DMF solution was reduced in concentration to 13 wt % PAN and 33 wt % tantalum(V) ethoxide/acetic acid solution was added to generate the fiber solution. The rheology of the fiber solution was investigated in comparison to the neat 15 wt % PAN/DMF solution. The rheological behavior of the two solutions were similar, as seen in FIG. 1(c). At relatively high shear rates the viscosity for the fiber solution in comparison to the 15 wt % PAN/DMF solution exhibited identical behavior, indicating that the Ta-ethoxide generates an additional interaction between the PAN chains in solution, resulting in similar fiber properties. The viscosity properties of solutions were compared at high shear rates because the force the solution encounters during the fiber spinning process is comparable to the force the solution experiences at high shear rates. This procedure was replicated for the Hf tert-butoxide/acetic acid solution. The fibers were generated at 3500 RPM with the collecting rods at 17.78 cm away from the spinneret from the fiber solutions.

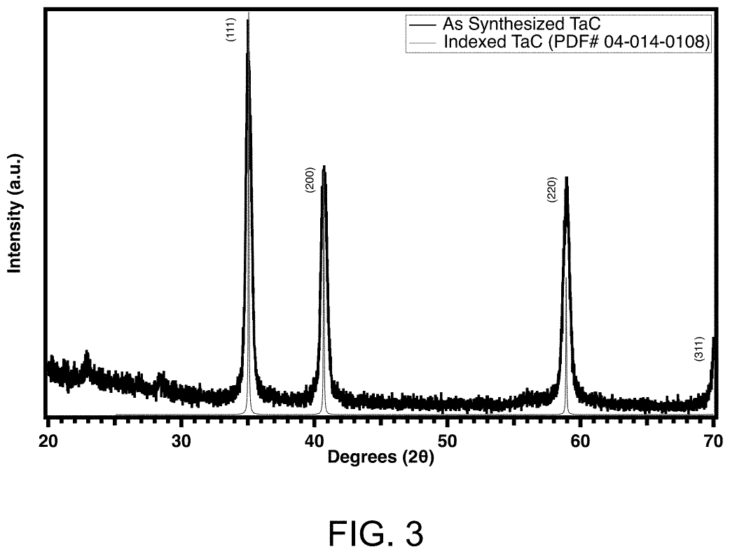

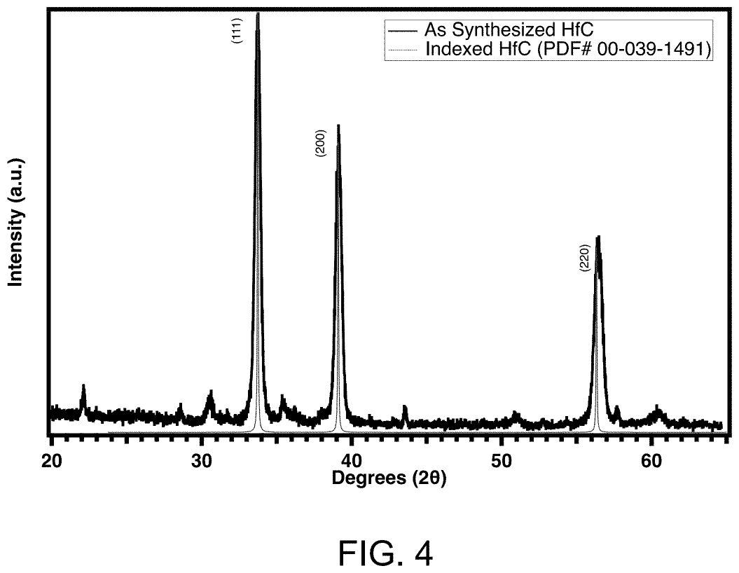

After green body curing at 220° C. and carbonization of the reagents at 1600° C., powder x-ray diffraction (PXRD) data was collected on the isolated products. As seen in FIG. 3, the product from the Ta solution yielded diffraction peaks at 35.5° (111), 40.7° (200), 58.9° (220), and 70.0° (311) which was indexed to TaC. See R. D. Vispute et al., Appl. Phys. Lett. 90(24), 3 (2007); J. Diani et al., Poly. Sci. Eng. 46(4), 486 (2006); C. Wang et al., Macromolecules 40(22), 7973 (2007); S. Padron et al., J. Appl. Phys. 113(2), 024318 (2013); S. Zhou et al., Mater. Lett. 200, 97 (2017); L. Feng et al., Ceram. Int. 41(9), 11637 (2015); and Z. Cui et al., New Carbon Mater. 32(3), 205 (2017). No tantalum oxide (Ta₂O₅) or any unreacted species were detected, given that that all peaks were indexed to TaC. There are small remnants of carbon as seen in this spectra and as further corraborated by thermogravimetric analysis (TGA). FIG. 4 presents the PXRD spectra of product obtained from the Hf solution. The spectra exhibited diffraction peaks at 33.4° (111), 38.8° (200), 56.1° (220) which was indexed to HfC. Remnants of hafnium oxide (HfO₂) were present as seen in the spectra, but the major product is HfC.

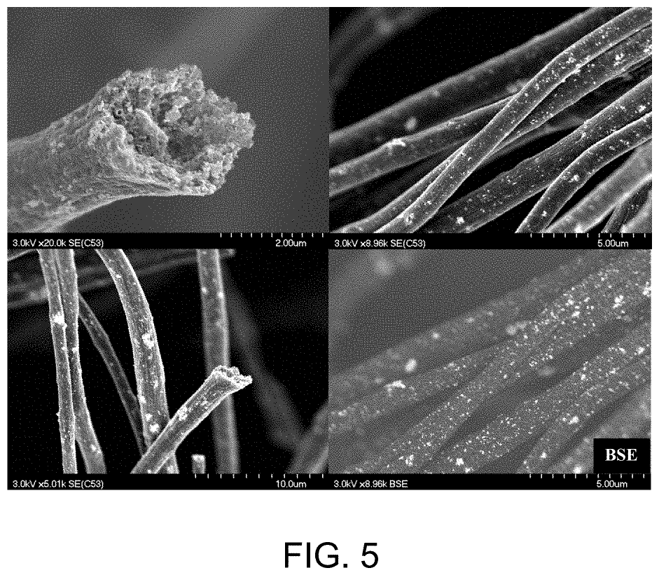

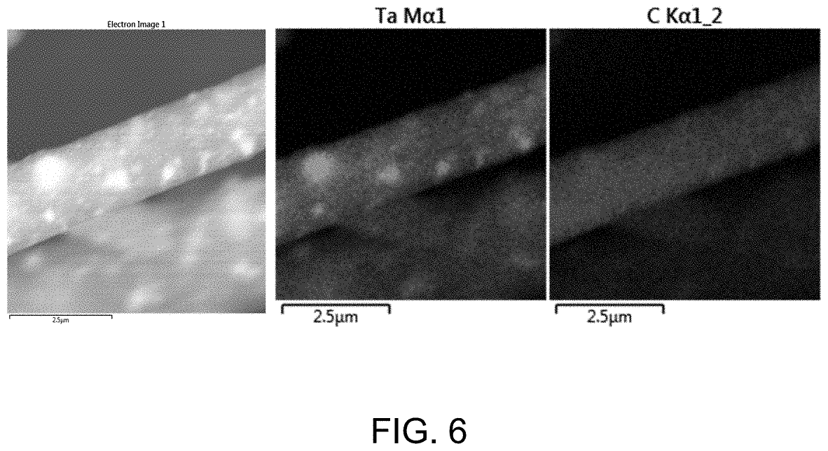

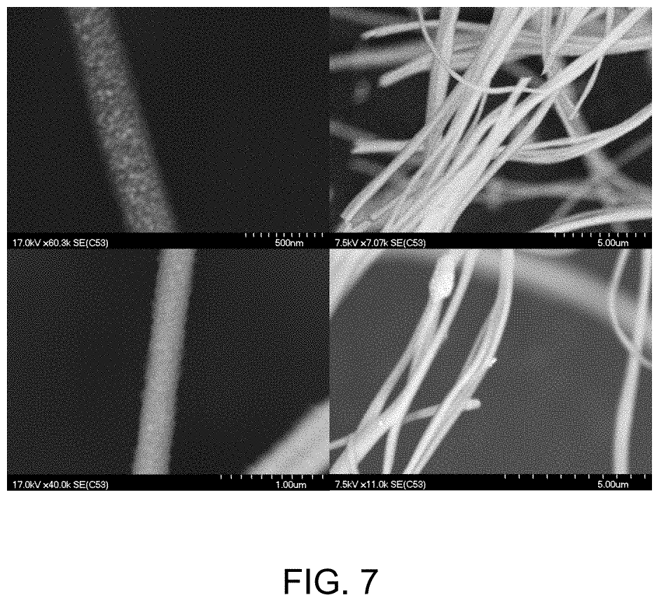

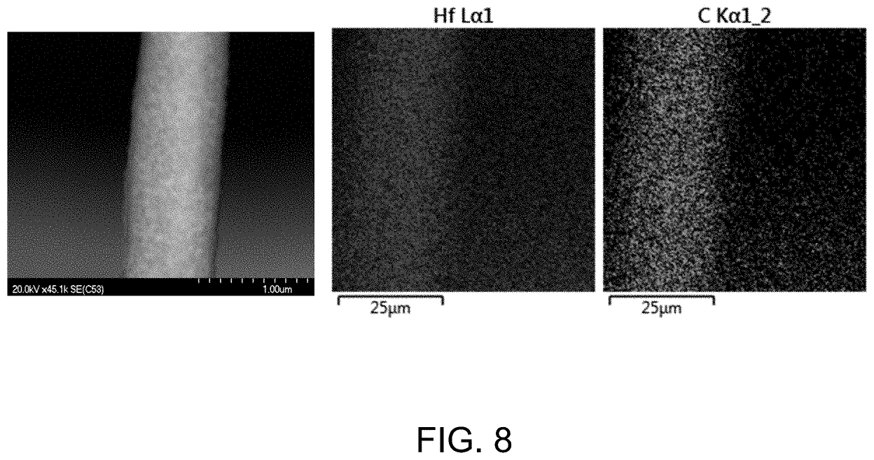

FIG. 5 shows SEM images of the as synthesized TaC fibers. The TaC fibers had an average diameter of 475 nm. FIG. 6 shows the SEM image and EDS images of tantalum and carbon collected on the TaC fibers. The EDS analysis confirms the presence of tantlum and carbon over the selected area. FIG. 7 shows the SEM images of the as synthesized HfC fibers. The HfC fibers had an average diameter of 475 nm. FIG. 8 shows the SEM image and EDS images of hafnium and carbon collected on the HfC fibers. The EDS analysis confirms the presence of hafnium and carbon over the selected area.

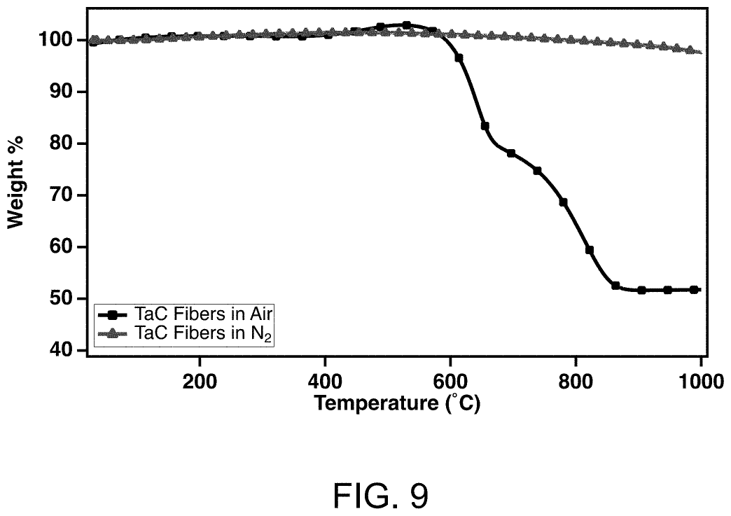

The TGA curve shown in FIG. 9 indicates that the TaC fibers were thermally stable below 450° C. while in air. After 450° C., an increase in mass was observed which is attributed to the oxidation of TaC to Ta₂O₅, as further verified by PXRD. See R. D. Vispute et al., Appl. Phys. Lett. 90(24), 3 (2007); and J. Diani et al., Poly. Sci. Eng. 46(4), 486 (2006). The oxidation mechanism of TaC yielded:

4TaC+9O₂→2Ta₂O₅+4CO₂

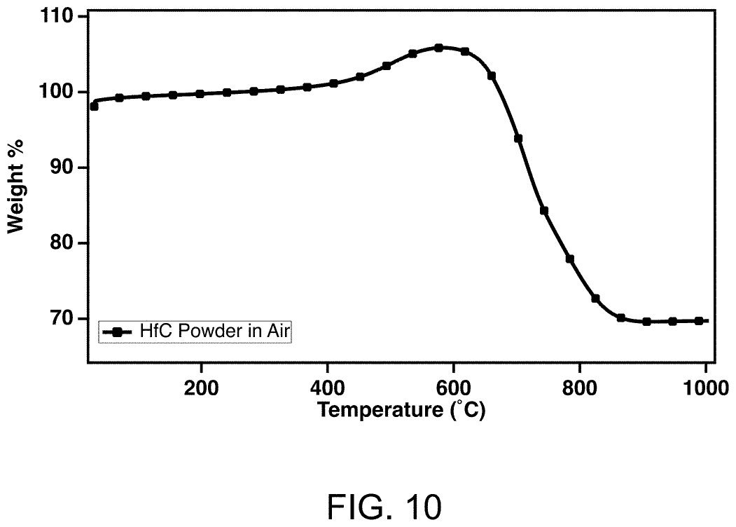

After 560° C., the weight loss was due to the oxidation of any free carbon present and loss of CO₂ from the system. See K. Sarkar et al., Mater. Today 13(11), 12 (2010). Also, as seen in FIG. 9, the fibers exhibited no change in mass (decomposition) under N₂. The TGA curve shown in FIG. 10 indicates that the synthesized HfC-fibers exhibited thermal stability below 450° C. while in air. After 450° C., an increase in mass was observed due to the oxidation of HfC to HfO₂, as further verified by PXRD. The oxidation of HfC yielded:

2HfC+4O₂→2HfO₂+2CO₂

The present invention has been described as a method to synthesize refractory transition metal-carbide fibers. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to synthesize refractory transition metal-carbide fibers, comprising:
providing a solution of polymer in a first solvent,
providing a solution of a refractory transition metal alkoxide in a second solvent,
combining the polymer solution with the refractory transition metal alkoxide solution to form a fiber solution,
Forcespinning™ the fiber solution to form fibers, and
carbonizing the fibers at an elevated temperature to form refractory transition metal-carbide fibers.

2. The method of claim 1, wherein the transition metal comprises Ta, Hf, Zr, or Nb.

3. The method of claim 1, wherein the transition metal tantalum(V) ethoxide or hafnium(IV) tert-butoxide).

4. The method of claim 1, wherein the polymer comprises polyacrylonitrile.

5. The method of claim 1, wherein the first solvent comprises dimethyl formamide.

6. The method of claim 1, wherein the second solvent comprises acetic acid.
